(19) United States
(12) Patent Application Publication
(10) Pub. No.: US 2014/0098105 A1
(43) Pub. Date: Apr. 10, 2014

(54) SYSTEMS AND METHODS FOR IMPROVED GRAPHICAL DISPLAY OF REAL-TIME DATA IN A USER INTERFACE

(71) Applicant: Anthony Ken Rund, Benicia, CA (US)

(72) Inventor: Anthony Ken Rund, Benicia, CA (US)

(73) Assignee: Chevron U.S.A. Inc., San Ramon, CA (US)

(21) Appl. No.: 13/648,850

(22) Filed: Oct. 10, 2012

(51) Int. Cl. G06T 11/20

(52) U.S. Cl. 345/440.2

(57) ABSTRACT

Disclosed are methods and systems for visually displaying and monitoring dynamic real-time values. Also disclosed is a non-transitory processor readable medium containing software instructions for carrying out the methods for visually displaying dynamic real-time values.

### FIELD

The present disclosure relates to systems and methods for displaying dynamic real-time data on a visual display of a user interface.

### BACKGROUND

Human machine interfaces (HMIs) are the user interfaces by which multiple equipment linked by a host control system are controlled. The host control system can be, for example, a programmable automation controller (PAC), programmable logic controller (PLC) or distributed control system (DCS). It has been recognized that the design of a user interface can affect the effectiveness of the user or operator in achieving the goals of the overall control system. When information is presented in a process control system graphical user interface in such a way that takes into account human psychological and physiological factors, the user is more likely to easily and effectively operate the overall control system.

The user interfaces of existing process control systems have not fully taken into account human psychological and physiological factors, or “human factors,” thus limiting their effectiveness and efficiency. For example, in most cases, operator interfaces of process control systems require that an alarm be read by the operator in order to decipher what is being communicated. In many cases, when one alarm is triggered in a process, other multiple alarms are triggered as well. This can result in a situation in which the operator is overwhelmed with information to interpret and choices to make regarding how to respond.

It would be desirable to have easier to monitor graphical user interfaces for monitoring dynamic real-time data that would better take advantage of human factors than existing user interfaces.

### SUMMARY

In one aspect, a computer-implemented method for graphically displaying dynamic real-time data on a visual display is provided. The method includes displaying a single bar chart comprising multiple bars along a central axis on a visual display in communication with a processor wherein the processor is in communication with a source of dynamic real-time data. At least one limit line representing a user-defined limit is displayed parallel to the central axis, selected from the group consisting of an upper alarm limit line, a lower alarm limit line, an upper deviation limit line, a lower deviation limit line, a maximum value line and a minimum value line. Each bar of the bar chart represents a real-time value retrieved from the source of dynamic real-time data and having a defined normal range, and the central axis represents the normal range for each of the real-time values. Each bar representing a real-time value within the normal range is indicated by a common sized bar on the axis of the bar chart, and each bar representing a real-time value outside the normal range is automatically scaled in size in proportion to the limit line closest to the real-time value. The bar chart is updated to reflect real-time values periodically.

In another aspect, a system for monitoring dynamic real-time data is provided which includes a user input device, a visual display and a computer processor in communication with a source of dynamic real-time data. The computer processor carries out the computer-implemented method described above.

In yet another aspect, a non-transitory processor readable medium containing computer readable software instructions used for displaying dynamic real-time data is provided.

### DESCRIPTION OF THE DRAWINGS

These and other objects, features and advantages of the present invention will become better understood with reference to the following description, appended claims and accompanying drawings where:

FIG. 1 is a block diagram illustrating components of an exemplary system disclosed herein;

FIG. 2 is a flowchart illustrating a method according to one embodiment disclosed herein; and

FIGS. 3 is a graphical display in a user interface according to exemplary systems and methods disclosed herein.

### DETAILED DESCRIPTION

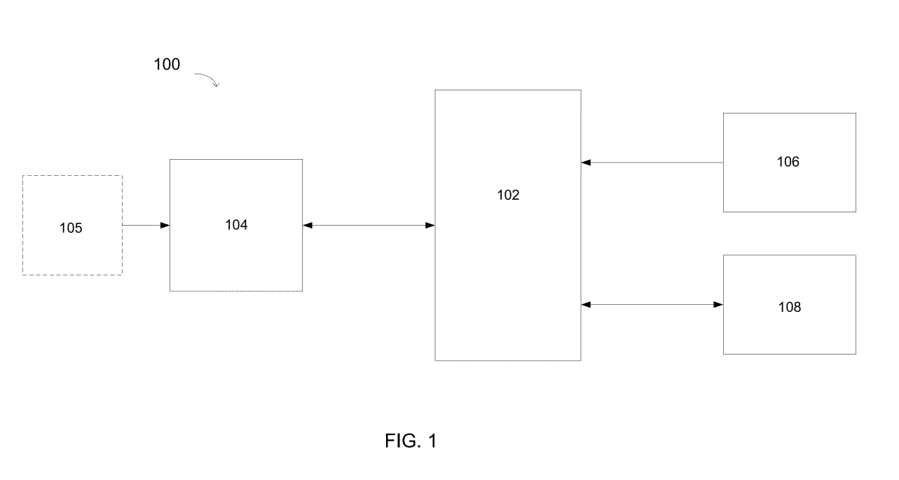

A system 100 for monitoring dynamic real-time data according to one embodiment is illustrated in FIG. 1. The system 100 includes a computer processor 102 in communication with a source of dynamic real-time data 104. The computer processor 102 is also in communication with a user input device 106 and a visual display 108. The computer processor 102 obtains a plurality of real-time values from the source of dynamic real-time data 104. The source of dynamic real-time data 104 can be a database which is updated periodically. The source of dynamic real-time data 104 is optionally in communication with a plurality of field instruments or sensors 105 for gathering real-time data. For instance, in one embodiment, the source of dynamic real-time data 104 is a process control system connected to sensors 105 to monitor a process. The process control system can be selected from the group consisting of a distributed control system, a programmable logic controller, a remote terminal unit and a supervisory control and data acquisition unit. A non-transitory processor readable medium containing computer readable software instructions used for displaying dynamic real-time data can be read by the processor 102. The computer processor 102 can include any suitable computer processor, such as at least one microprocessor containing at least one integrated circuit, for carrying out various functions according to the software instructions as would be apparent to one skilled in the art. The software instructions can be provided in a program in any programming language readable and executable by the processor 102.

The user input device 106 can be any convenient means by which a user can provide input to the computer processor 102, including, for example, a cursor, a keyboard, a touchscreen monitor or a microphone. The visual display 108 can be any visual display such as a computer monitor or a personal digital assistant (PDA) screen having sufficient resolution to display a profile including a bar chart having a plurality of individual bars, a central axis, and at least one limit line representing an alarm limit, a deviation limit or a minimum or maximum limit. Two or more elements of the system 100 can optionally be integrated in a single device. For example, in one embodiment, the user input device 106 and visual display 108 can be combined in a touchscreen visual display, e.g., as part of a computer monitor or a personal digital assistant (PDA).

In one embodiment, the computer processor 102 compares each of the plurality of real-time values to a predetermined normal range and a user-defined limit selected from an upper alarm limit, a lower alarm limit, an upper deviation limit, a lower deviation limit, a maximum value and a minimum value. In some cases, the normal range can be a single normal value, wherein the lower end of the range is the same as the upper end of the range.

The computer processor 102 generates signals which are communicated to the visual display 108 to generate a bar chart, also referred to herein as a “profile.” The bar chart is made up of multiple bars along a central axis and at least one limit line representing a user-defined limit parallel to the central axis. The limit line can be, for example, an upper alarm limit line, a lower alarm limit line, an upper deviation limit line, a lower deviation limit line, a maximum value line and/or a minimum value line. The profile can be a single bar chart displayed on a visual display 108. Alternatively, the profile can be displayed as two bar charts, each occupying a separate section or pane of the display. Alternatively, the profile can be displayed across more than one visual display 108.

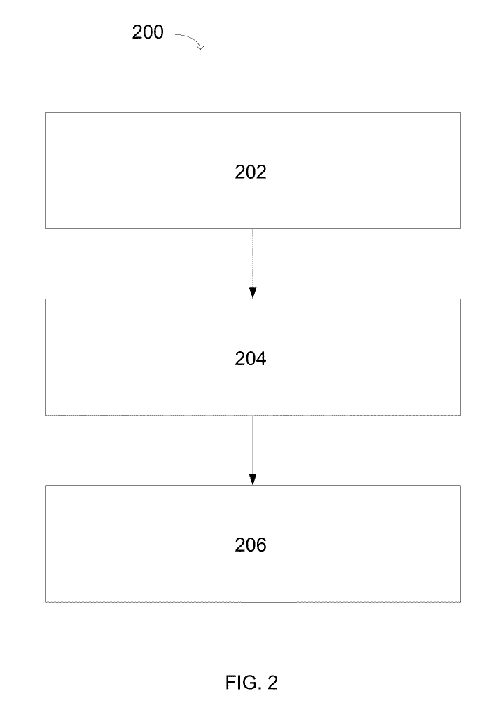

FIG. 2 is a flowchart illustrating a method 200 according to one embodiment. The steps of the method 200 are carried out by the processor 102 in accordance with the software instructions. In step 202, a signal indicative of a plurality of real-time values is processed. In step 204, each of the plurality of real-time values is compared to a predetermined normal range and a user-defined limit. The user-defined limit can be at least one of an upper alarm limit, a lower alarm limit, an upper deviation limit, a lower deviation limit, a maximum value and a minimum value. The term “alarm limit” generally refers to a value above or below which represents an elevated concern level for a particular parameter. The term “deviation limit” generally refers to a value above or below which a parameter should not be allowed to deviate as severe consequences can result beyond such limit. The terms “maximum value” and “minimum value” refer to the maximum and minimum possible values for a particular parameter, respectively.

In step 206, a signal for communication with a visual display is generated to produce a bar chart on the visual display comprising multiple bars along a central axis and at least one limit line representing a user-defined limit parallel to the central axis. Again, the user-defined limit can be at least one of an upper alarm limit line, a lower alarm limit line, an upper deviation limit line, a lower deviation limit line, a maximum value line and a minimum value line. The bar chart is updated to reflect real-time values periodically, as the table is updated.

The real-time values can be any type of dynamic data. Examples of real-time values include, but are not limited to, process parameters, price values, quality measurements, or any parameters used to discern the current status of an entity. The real-time values can be obtained from a database updated periodically with the changing values.

The real-time values can be process parameters obtained from a process control system which includes field instruments or sensors 105 for measuring process parameters. For example, the process parameters can include temperature measurements, pressure measurements, flow rate measurements, composition measurements, level measurements or any other measurement used to discern the status of an industrial process.

The real-time values can be stored as data in a table or database that is updated to reflect real-time values periodically. The table can be updated to reflect real-time values every user-defined increment of time. For example, the database can be updated every user-defined number of seconds or minutes. Alternatively, the database can be updated to reflect real-time values when the processor 102 automatically detects a signal indicating a change in one or more of the real-time values.

By way of example and not limitation, in one embodiment, the profile definition can be stored in a comma separated value (CSV) file. In one embodiment, the CSV file can be a worksheet created by Microsoft Excel. In this case, individual cells of the worksheet should contain no commas as this will disrupt the CSV format.

Table 1 below is an exemplary worksheet utilized in an exemplary system disclosed herein, shown for illustration purposes only. Shown are the top few rows of the worksheet. The first row is the header row which contains field names (column headers). For instance, in this example, “TAG” refers to a code for a real-time value of a parameter being monitored. “Description” refers to the description of the parameter.

In one embodiment, the table or worksheet is generated by first determining which parameters are to be included and ordering them to generally correspond to the flow of the process to which they refer. The number of parameters will depend on the number of important parameters to be monitored, and the size and level of resolution of the visual display. The number of parameters can be up to 400, even up to 500 and even up to 800.

TABLE 1

| | | | | | | | | | | | | | Measure- |
|---|---|---|---|---|---|---|---|---|---|---|---|---|---|
| | | | | | | Low | | High | | | | | ment |
| TAG | Description | Normal | NormalHi | SL | SH | Alarm | LDP | Alarm | HDP | Rgb | rGb | rgB | Type |
| 05FC006 | Fuel oil rundown | 37 | 53 | SL | SH | PL | LL | PH | HH | 135 | 255 | 125 | F |
| 02TI103 | Inlet temperature | 122 | 123 | 100 | 1000 | 300 | 250 | 500 | 550 | 135 | 255 | 125 | T |
| 05FC304 | Fuel oil to 690 | 2 | 8 | SL | SH | PL | LL | PH | HH | 135 | 255 | 125 | F |
| 02EI001 | Transformer1 | 20 | 30 | SL | SH | 02EX001 | 02EX002 | 02EX003 | 02EX004 | 38 | 244 | 48 | E |
| | Amps | | | | | | | | | | | | |
| 02EI002 | Transformer2 | 20 | 30 | SL | SH | PL | LL | PH | HH | 38 | 244 | 48 | E |
| | Amps | | | | | | | | | | | | |
| 02LC003 | Drum level | 16 | 16 | SL | SH | PL | LL | PH | HH | 38 | 244 | 48 | L |
| 02PI204 | Crude at batt | 1769 | 1788 | SL | SH | PL | LL | PH | HH | 38 | 244 | 48 | P |
| | limit | | | | | | | | | | | | |
| 02PI212 | 2D-1 pressure | 803 | 820 | SL | SH | PL | LL | PH | HH | 38 | 244 | 48 | P |

In Table 1, “Normal” refers to a low end of a normal range of a value. “NormalHi” refers to a high end of the normal range of the value.

“SL” refers to “scale low,” or a minimum possible value. “SH” refers to “scale high,” or a maximum possible value. “Low Alarm” refers to a value for a low alarm limit. “LDP” refers to a value for a low deviation limit. “High Alarm” refers to a value for a high alarm limit. “HDP” refers to a value for a high deviation limit. Note it is not necessary that all parameters have an alarm limit or a deviation limit.

“Rgb,” “rGb,” and “rgB” refer to color intensities used for the bars of the profile on the visual display, specifically red intensity, green intensity and blue intensity, respectively. A single color and shades of that color can be user-defined to correspond to values having some relation to one another, such as related subsections of a process.

“Measurement Type” refers to the type of parameter being represented, which is used to determine the pattern of the bars on the bar chart. In the example shown, measurement types include T (temperature), P (pressure), F (flow), L (level) or E (electric current) for bar patterns.

Additional field names can be included in the definition file as would be useful for a given profile, as would be apparent to one skilled in the art.

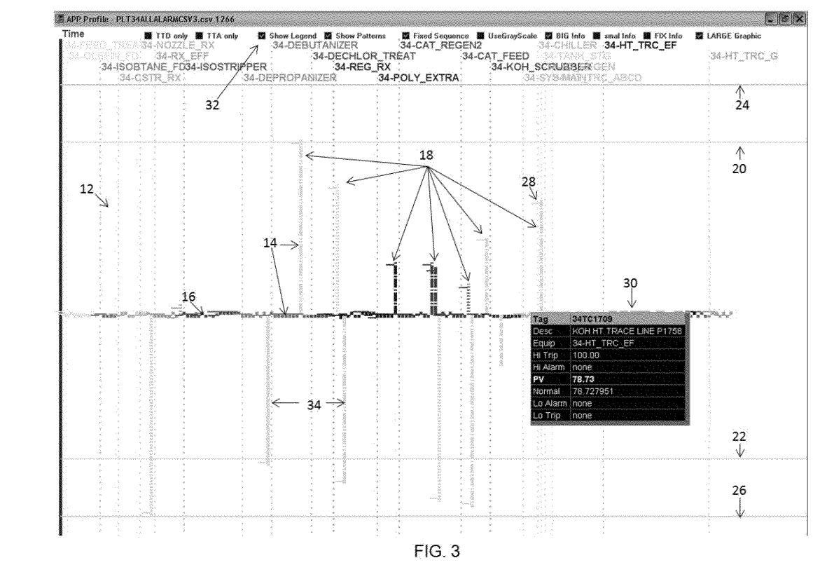

FIG. 3 illustrates an exemplary graphical display in a user interface according to one embodiment. Shown is a profile or bar chart 12 displayed on a visual display 108. Each bar 14 of the bar chart 12 represents a unique real-time value obtained from the source of dynamic real-time data 104.

The central axis 16 represents the normal values or normal ranges of all of the plurality of real-time values. Each bar representing a real-time value within the normal range is indicated by a common sized bar on the axis of the bar chart. For example, each of the bars 14 represent values which are within normal ranges, therefore they are represented by small bars along the central axis 16. Since all of the values within normal ranges are shown as the same size bar, anything outside of the normal range is easily identifiable.

Each bar representing a real-time value outside the normal range is automatically scaled in size in proportion to the limit line closest to the real-time value. For example, each of the bars 18 represent values which are outside normal ranges, therefore they are represented by bars which are proportionally scaled with respect to the nearest limit line. In FIG. 3, the limit lines shown are upper alarm limit line 20, lower alarm limit line 22, upper deviation limit line 24 and lower deviation limit line 26. If alarm limits or deviation limits are not defined, then the bar size is scaled according to its maximum or minimum possible value.

In some embodiments, the central axis is horizontal. In such cases, each bar representing a real-time value higher than the normal range is displayed above the central axis; and each bar representing a real-time value lower than the normal range is displayed below the central axis. In alternative embodiments, the central axis is vertical. In such cases, each bar representing a real-time value higher than the normal range is displayed to the right of the central axis; and each bar representing a real-time value lower than normal range is displayed to the left of the central axis.

The sequence of the bars in the bar chart can correspond to any convenient arrangement as would be apparent to the user or designer of the system. For instance, when the profile represents the performance of a process, the sequence of the bars can correspond generally to the order of the equipment in the process.

Each bar can have a user-defined pattern corresponding to the data type represented by the bar. In the case of a system to monitor the performance of a process, each bar can have a user-defined pattern corresponding to the process parameter type represented by the bar. For example, one pattern can represent temperature, another pattern can represent pressure, and so on.

A change over time in a real-time value represented by a bar on the bar chart can be indicated by a “rate of change marker” 28 on the bar. For instance, as shown, a small line segment having one endpoint in contact with the bar and one endpoint not in contact with the bar can be used as the rate of change marker. The endpoint not in contact with the bar indicates the value of the real-time value a predetermined increment of time in the past. In this way, the slope of the line segment indicates how far the bar has moved over the most recent period of time. A large slope indicates that the value has changed more significantly than a small slope. The rate of change marker can be used to predict the time until an alarm or deviation limit is reached. In one embodiment, such information is displayed in response to user input such as clicking on or moving the cursor over a bar. Real-time values expected to reach an alarm limit or a deviation limit within a defined period of time can be visually highlighted in response to user input. Other details can be displayed in response to user input, as would be apparent to one skilled in the art.

In one embodiment, the location of the rate of change marker with respect to the end of the bar can be used to indicate whether the real-time value represented by the bar has a deviation limit in addition to an alarm limit.

In response to user input, more details can be provided on any particular bar, as shown in the detailed information box 30. The type of detailed information provided can be configured to meet user's needs.

Various features can be turned on and off in response to user input. For instance, as shown, checkboxes 32 may be provided on the visual display providing the user with various options as would be apparent to the designer or user of such a system. In the example shown in the figure, by clicking the checkbox labeled “Show Legend,” the linked equipment descriptors become visible on the display.

As illustrated by bars 34, one or more bars of the bar chart can be visually deemphasized by changing from a normally assigned color of the bar to a color having low contrast with a background color in response to user input. The one or more visually deemphasized bar 34 can automatically revert to the normally assigned color if the real-time value represented by the bar changes more than a predetermined amount over a predetermined increment of time.

The user input can be via any convenient means, including a cursor controlled operation, a keyboard controlled operation, a touchscreen controlled operation or a voice controlled operation performed by the user.

Unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants, are intended to be non-limiting, such that recitation of items in a list is not to the exclusion of other like items that may also be useful in the materials, compositions, methods and systems of this invention.

From the above description, those skilled in the art will perceive improvements, changes and modifications, which are intended to be covered by the appended claims.

What is claimed is:

1. A computer-implemented method for graphically displaying dynamic real-time data on a visual display, comprising:
a. displaying a single bar chart comprising multiple bars along a central axis on a visual display in communication with a processor wherein the processor is in communication with a source of dynamic real-time data; and
b. displaying at least one limit line representing a user-defined limit parallel to the central axis, selected from the group consisting of an upper alarm limit line, a lower alarm limit line, an upper deviation limit line, a lower deviation limit line, a maximum value line and a minimum value line;
wherein:
i. each bar of the bar chart represents a real-time value retrieved from the source of dynamic real-time data and having a defined normal range;
ii. the central axis represents the normal range for each of the real-time values;
iii. each bar representing a real-time value within the normal range is indicated by a common sized bar on the axis of the bar chart;
iv. each bar representing a real-time value outside the normal range is automatically scaled in size in proportion to the limit line closest to the real-time value; and
v. the bar chart is updated to reflect real-time values periodically.

2. The method of claim 1, wherein the bar chart is updated to reflect real-time values every user-defined increment of time.

3. The method of claim 1, wherein the bar chart is updated to reflect real-time values when the processor automatically detects a signal indicating a change in one or more of the real-time values.

4. The method of claim 1, wherein each bar representing a real-time value higher than the normal range is displayed above or to the right of the central axis; and each bar representing a real-time value lower than the normal range is displayed below or to the left of the central axis.

5. The method of claim 1, wherein the real-time values are selected from the group consisting of process parameters, price values and quality measurements.

6. The method of claim 1, wherein the real-time values comprise process parameters obtained from a process control system, wherein the process parameters are selected from the group consisting of temperature measurements, pressure measurements, flow rate measurements, composition measurements and level measurements.

7. The method of claim 1, wherein the real-time values retrieved from the source of dynamic real-time data are stored in a database updated periodically.

8. The method of claim 1, further comprising graphically indicating a change over time in a real-time value represented by a bar on the bar chart by a rate of change marker comprising a line segment having one endpoint in contact with the bar and one endpoint not in contact with the bar; wherein the endpoint not in contact with the bar indicates the value of the real-time value a predetermined increment of time in the past.

9. The method of claim 8, wherein the location of the rate of change marker with respect to the end of the bar conveys whether the real-time value represented by the bar has a deviation limit in addition to an alarm limit.

10. The method of claim 1, further comprising displaying an estimated time until the real-time value represented by a bar reaches an alarm limit or a deviation limit in response to user input.

11. The method of claim 10, wherein the user input is a cursor controlled, keyboard controlled, touchscreen controlled or voice controlled operation performed by the operator.

12. The method of claim 1, further comprising visually highlighting real-time values expected to reach an alarm limit or a deviation limit within a defined period of time in response to user input.

13. The method of claim 6, wherein each bar is coded with a user-defined color corresponding to a subsection of the process.

14. The method of claim 6, wherein each bar comprises a user-defined pattern corresponding to the process parameter type of the process parameter represented by the bar.

15. The method of claim 6, wherein the sequence of the bars of the bar chart corresponds to the arrangement of corresponding equipment of the process.

16. The method of claim 1, further comprising visually deemphasizing one or more bars of the bar chart by changing from a normally assigned color of the bar to a color having low contrast with a background color in response to user input.

17. The method of claim 16, wherein the one or more visually deemphasized bar automatically reverts to the normally assigned color if the real-time value represented by the bar changes more than a predetermined amount over a predetermined increment of time.

18. A system for monitoring dynamic real-time data comprising:
a. a user input device;
b. a visual display; and
c. a computer processor in communication with a source of dynamic real-time data; wherein the computer processor:
i. obtains a plurality of real-time values from the source of dynamic real-time data;
ii. compares each of the plurality of real-time values to a predetermined normal range and a user-defined limit selected from the group consisting of an upper alarm limit, a lower alarm limit, an upper deviation limit, a lower deviation limit, a maximum value and a minimum value;
iii. generates on the visual display a single bar chart comprising multiple bars along a central axis and at least one limit line representing a user-defined limit parallel to the central axis, selected from the group consisting of an upper alarm limit line, a lower alarm limit line, an upper deviation limit line, a lower deviation limit line, a maximum value line and a minimum value line;
wherein:
1. each bar of the bar chart represents a real-time value obtained from the source of dynamic real-time data;
2. the central axis represents the normal range of each of the plurality of real-time values;
3. each bar representing a real-time value within the normal range is indicated by a common sized bar on the axis of the bar chart;
4. each bar representing a real-time value outside the normal range is automatically scaled in size in proportion to the limit line closest to the real-time value; and
5. the bar chart is updated to reflect real-time values periodically.

19. The system of claim 18, wherein the source of dynamic real-time data comprises a process control system comprising sensors for measuring process parameters.

20. The system of claim 19, wherein the process control system is selected from the group consisting of a distributed control system, a programmable logic controller, a remote terminal unit and a supervisory control and data acquisition unit.

21. A non-transitory processor readable medium containing computer readable software instructions used for displaying dynamic real-time data, the computer readable instructions comprising:
a. processing a signal indicative of a plurality of real-time values;
b. comparing each of the plurality of real-time values to a predetermined normal range and a user-defined limit selected from the group consisting of an upper alarm limit, a lower alarm limit, an upper deviation limit, a lower deviation limit, a maximum value and a minimum value; and
c. generating a signal for communication with a visual display to produce a bar chart on the visual display comprising multiple bars along a central axis and at least one limit line representing a user-defined limit parallel to the central axis, selected from the group consisting of an upper alarm limit line, a lower alarm limit line, an upper deviation limit line, a lower deviation limit line, a maximum value line and a minimum value line;
wherein:
i. each bar of the bar chart represents a real-time value obtained from a source of dynamic real-time data;
ii. the central axis represents the normal range of each of the plurality of real-time values;
iii. each bar representing a real-time value within the normal range is indicated by a common sized bar on the axis of the bar chart;
iv. each bar representing a real-time value outside the normal range is automatically scaled in size in proportion to the limit line closest to the real-time value; and
d. updating the bar chart to reflect real-time values periodically.
